(19) United States
(12) Patent Application Publication
(10) Pub. No.: US 2002/0091565 A1
(43) Pub. Date: Jul. 11, 2002

(54) Control system for agent websites

(76) Inventor: Yuan-Chieh Lee, Taipei (TW)

Correspondence Address: BACON & THOMAS, 625 Slaters Lane - 4th Floor, Alexandria, VA, 22314, US

(21) Appl. No.: 09/754,330

(22) Filed: Jan. 5, 2001

(51) Int. Cl. G06F 17/60; G06F 15/16

(52) U.S. Cl. 705/14; 709/202

(57) ABSTRACT

A novel control system for agent websites is provided. The invented control system for agent websites is used in an internet system comprising: at least one internet user site; at least one promoting website to provide advertisement services; at least one promoted website to be promoted by the promoting website for products, services or information available; and at least one agent website to control advertisement of said content generating website and accesses to said promoted website. When an internet user accesses to the promoting website from the user site, the user site is linked to the agent website, thereby the agent website provides advertisement information to the user site and the provided information is displayed on the screen of the user site. The agent website imports data saved in a recording file in the user site after it is linked with the user site. When the internet user selects a product, a service or information at the displayed advertisement information page from the user site, the selection (request) is forwarded first to the agent website, such that the agent website obtains data saved in the recording file, saves the data and, thereafter, links the user site to the promoted website. As a result, the advertisement information may be frequently updated and correct selection and transactions may be easily processed. Correct historical data of website visiting and transaction activities may be easily recorded.

### FIELD OF INVENTION

The present invention relates to a control system for an agent websites, especially to a control system for agent websites in the internet.

### BACKGROUND OF INVENTION

In the recent days, the internet has become an important marketplace for all kinds of produces and services. Many “agent websites” in the internet function as brokers or matchmakers of products and/or services provided. The agent websites utilized the wide spread network to catch the attention of internet users form all over the world to purchase products and services in the internet. On the other hand, the agent websites collected almost unlimited number and kinds of products and/or service in the virtual market. Some experts predicted that the agent website will become a major trend of the future business.

However, in the internet, buyers or visitors are physically spread in all areas of the world. For the agent websites it is not possible to build up personal relations with their buyers or visitors during their purchase or visiting activities. For these agent websites, how to make personal contacts with their customers in order to maintain the consumer relation or even to encourage the customers to continue their purchasing activities, has become a problem. These agent websites are trying every efforts to record or to investigate who the visitors/purchasers are so to build up their consumer relation and to create more business opportunities.

In addition to this, for these agent websites, advertisement is one of the most important source of income. In the previous days, income for advertisements is collected according to the “hit rate” of the websites. Nowadays, the advertisement expenses are collected according to the staying time of the visitors and the success rate of actual transactions. As a result, how to automatically generate statistic data for the staying time and the success rate of a website, or even a web page, has become the most task of most agent websites.

Nevertheless, the business style of the agent website has changed from passive to active. As the quantity and variety of products, services and information collected and provided in the agent website are growing so fast that the internet users have lost their patience searching (surfing) in the internet for products, services and information of interests. The agent websites have to provide efficient navigation tools for their visitors and customers according to their specific needs and interests. It is thus necessary to provide a navigation device in the internet to record the visiting and purchasing activities of customers and efficiently provide them with information of products, service and information to comply with their needs or interests at the first place.

### OBJECTIVES OF INVENTION

The object of this invention is to provide a control system for agent websites to simplify the supply of advertisement information in the internet.

Another object of this invention is to provide a control system for agent websites to execute correct display and selections of advertisement information.

Another objective of this invention is to provide a control system for agent websites to automatically and correctly record the visiting and transaction activities of internet users.

Another objective of this invention is to provide a control system for agent websites to automatically record the visiting activities of internet users in order to provide navigation services.

Another objective of this invention is to provide a control system for agent websites such that no additional hardware or specific software is needed in a website providing advertisement information.

### SUMMARY OF INVENTION

According to the present invention, a control system for agent websites is provided. The control system for agent websites is used in an internet system comprising: at least one internet user site; at least one promoting website to provide advertisement services; at least one promoted website to be promoted by the promoting website for products, services or information available; and at least one agent website to control advertisement of said content generating website and accesses to said promoted website. According to the invented control system for agent websites, when an internet user accesses to the promoting website from the user site, the user site is linked to the agent website, thereby the agent website provides advertisement information to the user site and the provided information is displayed on the screen of the user site. The agent website imports data saved in a recording file in the user site after it is linked with the user site. When the internet user selects a product, a service or information at the displayed advertisement information page from the user site, the selection (request) is forwarded first to the agent website, such that the agent website obtains data saved in the recording file, saves the data and, thereafter, links the user site to the promoted website. As a result, the advertisement information may be frequently updated and correct selection and transactions may be easily processed. Correct historical data of website visiting and transaction activities may be easily recorded.

These and other objectives and advantages of this invention may be clearly understood from the detailed description by referring to the following drawing.

### BRIEF DESCRIPTION OF DRAWING

FIG. 1 illustrates the system flow chart of the control system for agentr websites of this invention.

### DETAILED DESCRIPTION OF INVENTION

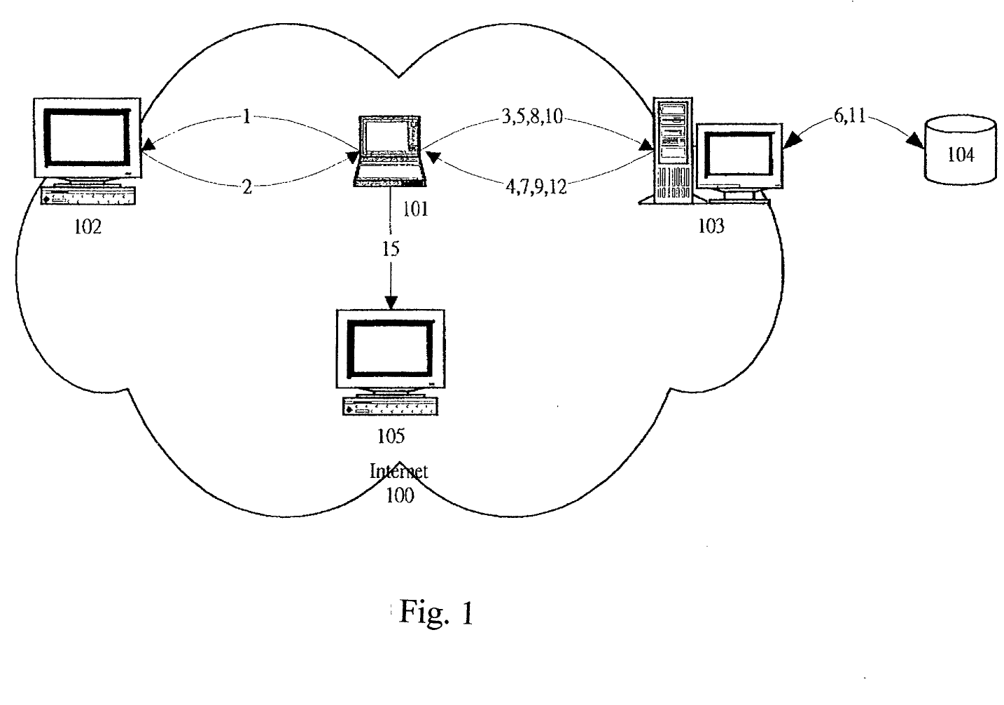

FIG. 1 illustrates the system flow chart of the control system for agent websites of this invention. As shown in this FIGURE, the control system for agent website of this invention is used in the internet 100 comprising at least one internet user site 101 with which an internet user accesses the internet 100. The user site 101 is linked to a particular website 102 through the internet under a network communication protocol, such as the uniform resource locators (URL). Website 102 functions as an advertisement service providing website for products, services and/or information provided by other websites. The website 102 may be called a promoting website.

The internet 100 also comprises an agent website 103. This agent website 103 functions as agent or distributor for products, services and/or information as displayed in the web page of the promoting website 102. Agent website 103 may also function as agent of the advertisement service, i.e., agent to the promoting website 102. In general cases, the agent website 103 also provides, among others, advertisement information for the products, services and/or information provided by the promoting website 102. As a result, both the promoting website 102 and the agent website 103 provide the same advertisement information at the same time to catch more attention of the internet users.

When the agent website 103 is agent or distributor to the products, services and/or information being displayed in the promoting website 102, its function is to enable the user site 101 to link to the promoting website 102 via the advertisement information page as provided by the promoting website 102. After the internet user obtains the displayed advertisement information, the internet user may put a purchase order by clicking at a predetermined location on the displayed web page of the promoting website 102. At the agent website 103, a database in which all kinds of useful information of the products, services and/or information being promoted, such as suppliers, quantity in stock etc., are stored

When the internet user sends a purchase order from the user site 101, the purchase order is forwarded to a promoted website 105. The promoted website 105 is supplier of the promoted products, services and/or information. The promoted website 105 may also be the warehouse of the agent website 103. Upon receipt of the purchase order, the promoted website 105 delivers the products, services and/or information to the internet user to complete a transaction.

If the agent website 103 is an advertisement agent, when an internet user sends a purchase order for a certain product, service or information by clicking a predetermined location of the web page of the promoting website 102, the user site 101 will be linked directly to the promoted website 105. The promoted website 105 will then deliver the ordered product, service or information to the internet user through its standard delivery channel. In that case, record of the transaction is not forwarded to the agent website 103. The visiting activities and the purchasing activities of the internet user is recorded by the promoting website 102 and the promoted website 105, respectively.

In the conventional art, when the agent website 103 does not provide advertisement information, it is not possible for the agent website 103 to utilize the visiting and purchasing requests of the internet user, because the visiting activities and purchasing activities of the internet user are recorded by and saved at the promoting website 102 and the promoted website 105. In addition, if the internet user does not send a purchase order, record of such a visiting activity does not include the personal information of the internet user. As a result it is not possible for the agent website 103 to provide further services, including navigation services to the internet user according to the past visiting activities of the internet user.

In the conventional art, if the advertisement information provided by the promoting website 102 is more than one page, it is necessary to provide a plurality of broadcasting addresses for the provided information at the agent website 103. In such a circumstance, it is necessary to install proper software at the promoting website 102, such that the request of different broadcasting addresses may be forwarded to and be executed by the agent website 103. Of course it is possible for the promoting website 102 to provide the advertisement information from only one broadcasting address. However, in doing so, special design in the communication between the promoting website 102 and the agent website 103 is needed. As a result, the compatibility of the hardware and the software between them becomes a problem to be solved.

In order to solve these problems, the control system for agent websites of this invention provides a novel method of communication among the agent website, the promoting website and the promoted website. When the user site 101 is linked to the promoting website 102 to request relative advertisement information, the promoting website 102 forwards a web page or web pages to the user site 101 and links the user site 101 to the agent website 103. The agent website 103 then takes charge to supply advertisement information to the user site 101 and to conduct the following operations. Under such a design, the requested advertisement information may supplied by the agent website 103 from a constant host IP address and a constant information broadcasting address. When the internet user selects another information column from the web page of the promoting website 102, the broadcasting address of the agent website 103 may be shifted to another. However, when another information page of the same information column is requested or when the information page is shifted to another by rotation or by any other reason, the broadcasting address is not changed. It is thus possible for the promoting website 102 to virtually provide a variety of advertisement information at the same address, as long as the same information column is selected. As a result, no special software is needed to satisfy the need in providing various advertisement information at the promoting website. The problems of the compatibility between the hardware and the software and the compatibility between the systems of the promoting website 102 and the agent website 103 may be solved.

In the present invention, when the user site 101 is linked to the agent website 103, the agent website 103 imports a record file from the user site 101. The record file may be a particular file stored in the user site 101. Preferably, in the record file useful personal information of the user site 101 or the internet user is saved. In the application of this invention, if no such record file exists at the user site 101, a record file is created by the website 103. When the record file is created or found, the agent website 103 will insert a code in the record file to record the advertisement information requested by the and forwarded to the user site 101.

As described above, in the conventional art, when the internet user selects a particular web page or information and the user site 101 is ready to enter the transaction procedure, the request is directly forwarded to the promoted website 105, for which the products, services and/or information is being advertised. As a result, it is impossible for the agent website 103 to record the purchasing activities of the internet user, so to provide other valuable services.

In the present invention, when the internet user selects a particular web page or information and the user site 101 is ready to enter the transaction procedure, the request is forwarded to the agent website 103, instead of to the promoted website 105 directly. At this step, the agent website 103 allocates the record file in the user site 101 as well. The purchase request is then recorded in the record file and, thereafter, the user site 101 is linked to the promoted site 105.

Under the control system for agent websites of this invention, the visiting activities and purchasing activities of internet user may be recorded in detailed correctly and customized navigation and other valuable services may thus be created and provide to the internet user, according to the history of the internet user's visiting and/or purchasing behaviors.

The following is a detailed description of the operation of the control system for agent websites of this invention, as is used in the provision of advertisement information. FIG. 1 illustrates the system flow chart of the control system for agent websites of this invention. In this FIGURE, the numbers represent the flowing steps in sequence:

At step 1, the user site 101 is linked to the promoting website 102 under a network communication protocol, such as URL. A particular web page providing particular advertisement information is being requested by the user site 101.

At step 2, upon such a request, the promoting website 102 forwards a page containing a column designated to the requested advertisement information to the user site 101 and links the user site 101 to the agent website 103. Under such a linkage, all advertisement information provided to the user site 101 is supplied by the agent website 103. All advertisement information designated by the selected column is provided from a constant broadcasting address and the same host IP address. When the internet user selects another column from the web page provided by the promoting website 102, the broadcasting address may be changed. However, changes of advertisement information being supplied does not change the broadcasting address, as long as the selected column is not changed. As a result, it is not necessary to install any additional hardware or software at the promoting website 102 in order to supply to internet users a variety of advertisement information.

At step 3, the user site 101 forwards the personal information of the internet user to the agent website 103. The personal information of the internet user may include the email address or domain address, access time and other information of the internet user or the user site 101 .

At step 4, the agent website 103 links itself to the user site 101 by using the personal information supplied by the user site 101.

At step 5, the agent website 103 allocates a record file in the user site 101 and the user site 101 forwards its email address or domain address to the agent website 103. Here, the record file may be a file provided with membership number of the internet user and other information such as name, birthday, area of domicile, address, telephone number, sex, email address etc., which may be taken for reference in providing valuable services to the internet user. If no such record file exists in the user site 101, a message representing failure in allocating such a record file is forwarded to the agent website 103 along with the address of the sure site 101 in the internet 100. At this moment, the agent website 103 creates a record file in the user site 1101 and gives it a membership number.

At step 6, the visiting activity of the internet user and the relative membership number is saved in a database 104 of the agent website 103 to be taken for reference in the statistics, analysis and services of the agent website 103. The information as saved in the database 104 includes the address of the internet user, access time, advertisement information having been viewed or selected, or other useful information saved in the record file of the user site 101.

At step 7 the environment of the user site 101 and the advertisement information being displayed are recorded in the record file of the user site 101. Here, the record file is the one allocated or created by the agent website 103 in the previous steps. In some embodiments of this invention, the environment of the user site 101 includes series number of viewing window created at the user site 101, or any information representing the executing environment at the moment when an advertisement information page is being viewed.

The above steps are repeated, when the advertisement information being supplied is changed, as long as the internet user does not select another column in the web page of the promoting website 102. The advertisement information may change by rotation.

At step 8, the internet user inputs a purchase instruction at the user site 101. At this moment, data representing advertisement information being displayed/viewed, as well as the address of the user site 101 and time of display, are forwarded to the agent website 103.

At step 9, the agent website 103 links itself to the user site 101 according to the address provided by the user site 101.

Thereafter, at step 10, the agent website 103 reads the record file from the user site 101 and records the operation environment of the user site 101. Here, the operation environment of the user site 101 may be used to match to an advertisement information file or code, representing the advertisement information being displayed, in the database 104.

At step 11, the information saved in the record file of the user site 101 is saved in the database 104. The saved information includes the address of the user site 101, the access time of the user site 101, the advertisement information being displayed, viewed and/or selected and other information that is useful in providing valuable services to the internet user.

At step 12, the agent website 103 redirects the user site 101 to the promoted website 105.

Thereafter, at step 13, the user site 101 is linked to the promoted website 105 to complete the purchase transaction. Before the user site 101 is linked to the promoted website, the purchasing activities of the internet user are recorded by the agent website 103.

In the process as described above, the linkages are conducted within a very short time, such that no inconvenience will be brought to the internet user.

### EFFECTS OF INVENTION

As described above, the control system for agent websites of this invention links the user site to the agent website during the most important period of the displaying, viewing and selection of advertisement information. Correct records of personal information, web page visiting activities and selecting/purchasing activities may be easily obtained.

In the control system for agent websites of this invention, the advertisement information being display/viewed is recorded at the user site, such that correct displaying and selection functions may be provided by the agent website. There is not need to install any additional hardware or software at the promoting website. Incompatibility problems between the agent website and the promoting website may thus be avoided.

As the present invention has been shown and described with reference to preferred embodiments thereof, those skilled in the art will recognize that the above and other changes may be made therein without departing form the spirit and scope of the invention.

What is claimed is:

1. A control system for agent websites to be used in an internet system comprising:
at least one internet user site equipped with an internet accessible computer;
at least one promoting website to promote products, services and/or information in said internet system and to provide at least one advertisement web page;
at least one promoted website to allow transaction of products, services and/or information being promoted by said promoting website; and
at least one agent website to control displaying and selection of advertisement information at said advertisement web page of said promoting website;
characterized in that said control system links said internet user site to said agent website after said internet user site is linked to said promoting website and said advertisement web page is provided to said internet user site, such that said agent website supplies a predetermined advertisement information to said internet user site and that said advertisement web page and predetermined advertisement information are displayed at said internet user site in combination;
that said control system requests said agent website to allocate a recording file in said internet user site or to create a recording file in said internet user site, if no recording file is allocated in said internet user site; wherein said recording file records at least address of said internet user site in said internet and data representing said predetermined advertisement information; and
that, when a selection instruction is input from said internet user site, said control system forwards said instruction to said agent website to actuate said agent website to pick up data in said recording file and links said internet user site to said promoted website to execute a purchase transaction.

2. The control system for agent websites according to claim 1 wherein data saved in said recording file comprises a membership number, a name, a birthday, a domicile area, sex identification, an email address and/or a domicile address.

3. The control system for agent website according to claim 1 wherein data saved in said recording file comprises operation environment of said internet user site corresponding to advertisement information being displayed.

4. A control system for agent website to be used in an internet system comprising:
at least one internet user site equipped with an internet accessible computer;
at least one promoting website to promote products, services and/or information in said internet system and to provide at least one advertisement web page;
at least one promoted website to allow transaction of products, services and/or information being promoted by said promoting website; and
at least one agent website to control displaying and selection of advertisement information at said advertisement web page of said promoting website;
said method comprising the following steps:
linking said internet user site to said agent website after said internet user site is linked to said promoting website and said advertisement web page is provided to said internet user site, such that said agent website supplies a predetermined advertisement information to said internet user site and that said advertisement web page and predetermined advertisement information are displayed at said internet user site in combination;
requesting said agent website to allocate a recording file in said internet user site or to create a recording file in said internet user site, if no recording file is allocated in said internet user site; wherein said recording file records at least address of said internet user site in said internet and data representing said predetermined advertisement information; and
when a selection instruction is input from said internet user site, forwarding said instruction to said agent website to actuate said agent website to pick up data in said recording file and linking said internet user site to said promoted website to execute a purchase transaction.

5. The control system for agent websites according to claim 4, further comprising a step of importing data of said recording file and said selection instruction in said agent website when a selection instruction is input from said internet user site.

6. The control method for agent websites according to claim 4 or 5 wherein data saved in said recording file comprises a membership number, a name, a birthday, a domicile area, sex identification, an email address and/or a domicile address.

7. The control system for agent website according to claim 4 or 5 wherein data saved in said recording file comprises operation environment of said internet user site corresponding to advertisement information being displayed.
